(19) United States
(12) Patent Application Publication
(10) Pub. No.: US 2023/0199753 A1
(43) Pub. Date: Jun. 22, 2023

(54) INCREMENTAL SIGNALING METHOD FOR CROSS-SLOT SCHEDULING AND BURSTY TRAFFIC

(71) Applicant: Fraunhofer-Gesellschaft zur Foerderung der angewandten Forschung e.V., Munich (DE)

(72) Inventors: Prasanth KARANUKARAN, Erlangen (DE); Julian POPP, Erlangen (DE); Clemens KORN, Erlangen (DE); Josef BERNHARD, Erlangen (DE); Baris GÖKTEPE, Berlin (DE); Thomas FEHRENBACH, Berlin (DE); Thomas WIRTH, Berlin (DE); Cornelius HELLGE, Berlin (DE); Thomas SCHIERL, Berlin (DE)

(21) Appl. No.: 18/170,386

(22) Filed: Feb. 16, 2023

Related U.S. Application Data
(63) Continuation of application No. PCT/EP2021/072736, filed on Aug. 16, 2021.

(30) Foreign Application Priority Data
Aug. 17, 2020 (EP) 20191414.0

(51) Int. Cl. H04W 72/1263; H04W 72/20

(52) U.S. Cl. CPC H04W 72/1263; H04W 72/20

(57) ABSTRACT

Embodiments provide a transceiver [e.g., UE] of a wireless communication system, wherein the transceiver is configured to receive a first control message [e.g., in a first slot or subframe, such as slot or subframe n] [e.g., comprising a first control information or control configuration], wherein the transceiver is configured to receive a second control message [e.g., in a second slot or subframe, such as slot or subframe n+koff−Δ] [e.g., comprising a second control information or control configuration], wherein the second control message is linked [e.g., refers] to the first control message by an identifier, ID [e.g., DCI/base grant ID], or indication, wherein one out of
the first control message,
the first control message and the second control message together,
the second control message,
   grant or assign a resource to the transceiver for a communication of the transceiver.

### CROSS-REFERENCE TO RELATED APPLICATIONS

This application is a continuation of copending International Application No. PCT/EP2021/072736, filed Aug. 16, 2021, which is incorporated herein by reference in its entirety, and additionally claims priority from European Application No. EP20191414.0, filed Aug. 17, 2020, which is also incorporated herein by reference in its entirety.

Embodiments of the present application relate to the field of wireless communication, and more specifically, to allocating or scheduling of grants. Some embodiments relate to incremental signaling method for cross-slot scheduling and bursty traffic.

### BACKGROUND OF THE INVENTION

FIG. 1 is a schematic representation of an example of a terrestrial wireless network 100 including, as is shown in FIG. 1(a), a core network 102 and one or more radio access networks RAN1, RAN2, . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/ LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g. via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g. via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. All OFDM symbols may be used for DL or UL or only a subset, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs.
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g. GSM, UMTS, LTE base stations.

When considering two UEs directly communicating with each other over the sidelink, e.g. using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a communication system as described above, such as NR (5G), dynamic scheduling grants where introduced where the grant received by a UE on a PDCCH in slot n allocates a time-frequency resource for data reception in slot n+koff, where koff is an offset. The standard symbols k0 and k1 indicate the offsets in downlink and uplink, respectively. Such a concept is referred to as cross-slot scheduling.

Depending on the value of koff, the time gap between the grant and data reception can be small or large. The values of koff in 5G can be in the range {0,1, . . . , 32}. The concept of k0 for PDSCH in 5G is illustrated in FIG. 6.

Specifically, FIG. 6 shows an illustrative view of the k0 offset (scheduling) in the downlink [1]. As shown in FIG. 6, the offset k0 received from a gNB by a UE in slot n allocates a resource to the UE in slot n+k0. This time domain resource assignment can be performed, for example, using the DCI 1_0 or 1_1 format. This can specify an index in the table specified in RRC parameter, such as PDSCH-TimeDomainResourceAllocation.

In FIG. 6, S denotes the start symbol and L the length of consecutive symbols. Both, the start symbol s and the length l of consecutive symbols can be determined by SLIV (start and length indicator). The SLIV can be specified in a RRC parameter, such as PDSCH-TimeDomainResouceAllocation.

Several values of koff can be configured to a UE using RRC signaling (e.g., using the PDSCH-TimeDomainResourceAllocationList information element). A DCI scheduling grant specifies which of these configured koff is valid for the grant. A grant also includes transmission parameters such as modulation and coding scheme, time domain resource assignment, frequency domain resource assignment, HARQ process number, TPC for PUSCH, antenna ports, number of layers, PMI for PUSCH etc.

A first problem is that for grants with large values of koff, there is a large time gap between grant and the allocation. As a result of this delay, a subset of the transmission parameters indicated in the grant may become outdated or unsuitable. For example, the channel quality may change and the gNB may wish to update the modulation and coding scheme or number of layers. As another possibility the gNB may even wish to cancel the allocation or postpone the allocation to make way for a higher priority transmission for another UE. In another case, a gNB may wish to use the allocation for a different HARQ process to satisfy latency/reliability requirement. Similarly, other examples where a modification of the indicated transmission parameters in the grant is beneficial may be found.

Presently, the 5G standard does not support efficient dynamic modification of grant transmission parameters.

A second problem is that when frequent allocations are needed (but not necessarily in a deterministic pattern), it is inefficient to send frequent PDCCH based grants or use semi-persistent scheduling/configured grants. If the DCI size can be reduce, it can reduce overhead and also reduce power consumption. An improved DCI scheduling grant procedure may be beneficial in this situation.

DCI piggyback over PDSCH can help a lot for power saving [2]. The UE does not need to keep monitoring control frequently. Instead, the UE can monitor a sparse control over time, and if there is data for the UE, the DCI can be piggyback in the PDSCH portion to keep the UE scheduled. On the other hand, this functionality can also be achieved with DRX design. For example, a UE can monitor control indication during DRX ON portion. If there is data for the UE, the UE will stay awake to monitor more control information.

Starting from the above, there is a need for improvements or enhancements with respect to allocating or scheduling of grants.

It is noted that the information in the above section is only for enhancing the understanding of the background of the invention and therefore it may contain information that does not form conventional technology and is already known to a person of ordinary skill in the art.

### SUMMARY

An embodiment may have a transceiver of a wireless communication system, wherein the transceiver is configured to receive a first control message, wherein the transceiver is configured to receive a second control message, wherein the second control message is linked to the first control message by an identifier, ID, or indication, wherein the first control message and the second control message together grant or assign a resource to the transceiver for a communication of the transceiver.

Another embodiment may have a transceiver of a wireless communication system, wherein the transceiver is configured to transmit a first control message, wherein the transceiver is configured to transmit a second control message, wherein the second control message is linked to the first control message by an identifier, ID, or indication, wherein the first control message and the second control message together grant or assign a resource to another transceiver for a communication of the other transceiver.

According to another embodiment, a method for operating a transceiver may have the steps of: receiving a first control message, receiving a second control message, wherein the second control message is linked to the first control message by an identifier, ID, or indication, wherein the first control message and the second control message together grant or assign a resource to the transceiver for a communication of the transceiver.

According to another embodiment, a method for operating a transceiver may have the steps of: transmitting a first control message, transmitting a second control message, wherein the second control message is linked to the first control message by an identifier, ID, or indication, wherein the first control message and the second control message together grant or assign a resource to another transceiver for a communication of the other transceiver.

Another embodiment may have a non-transitory digital storage medium having a computer program stored thereon to perform any of the inventive methods when said computer program is run by a computer.

### BRIEF DESCRIPTION OF THE DRAWINGS

Embodiments of the present invention will be detailed subsequently referring to the appended drawings, in which:

FIG. 1a-b shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 shows an illustrative view of the k0 offset (scheduling) in the downlink [1];

FIG. 7 is a schematic representation of a wireless communication system comprising a transceiver, like a base station or a relay, and a plurality of communication devices, like UEs, according to an embodiment;

FIG. 8 shows in a diagram an illustrative view of a transmission of control messages for allocating/scheduling a grant and modifying said grant, in accordance with an embodiment;

FIG. 9 shows in a diagram an illustrative view of a transmission of a sequence of control messages for allocating/scheduling grants for bursty traffic, according to an embodiment.

FIG. 10a shows in a diagram an illustrative view of a transmission of a sequence of control messages, the control messages comprising control information updating a base grant (delta signaling), according to an embodiment of the present invention;

FIG. 10b shows in a diagram an illustrative view of a transmission of a sequence of control messages, the control messages comprising control information updating a base grant (delta signaling), according to an embodiment of the present invention;

FIG. 11 shows in a diagram a scenario where incremental DCI is not received correctly, according to an embodiment; and

FIG. 12 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

The present invention provides approaches for improving allocating or scheduling of grants, so as to provide, for example, improvements, for example, in terms of power consumption, flexibility, complexity, forward compatibility, overhead, latency, robustness, reliability.

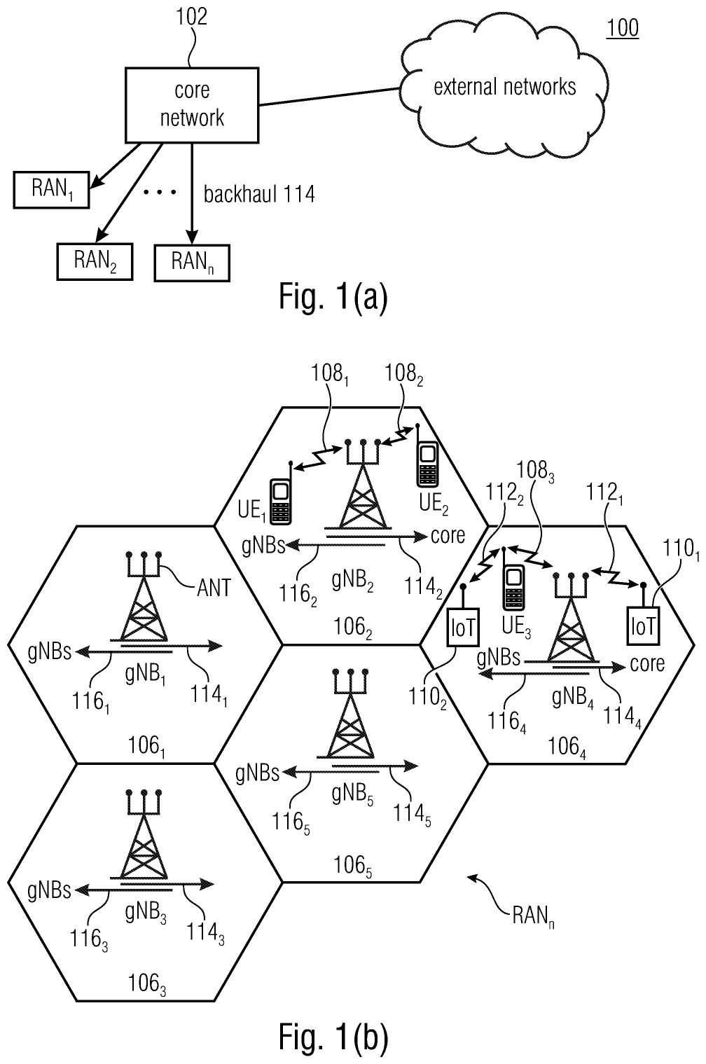

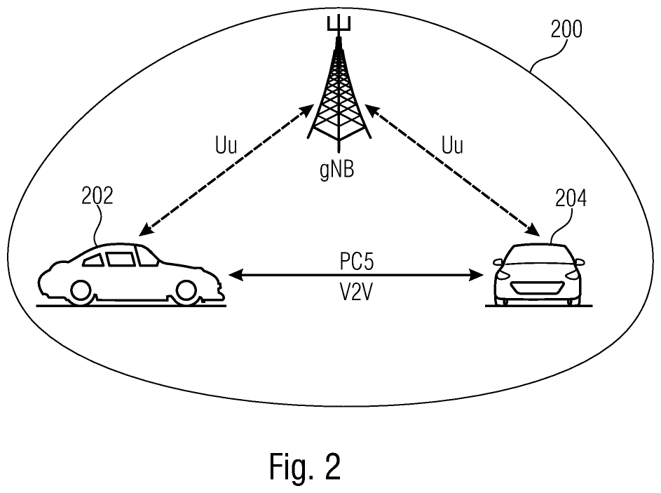

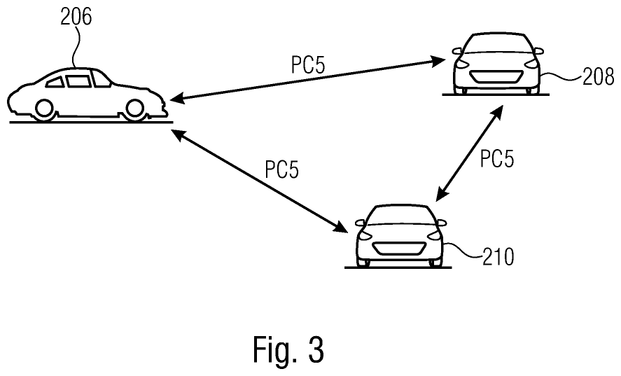

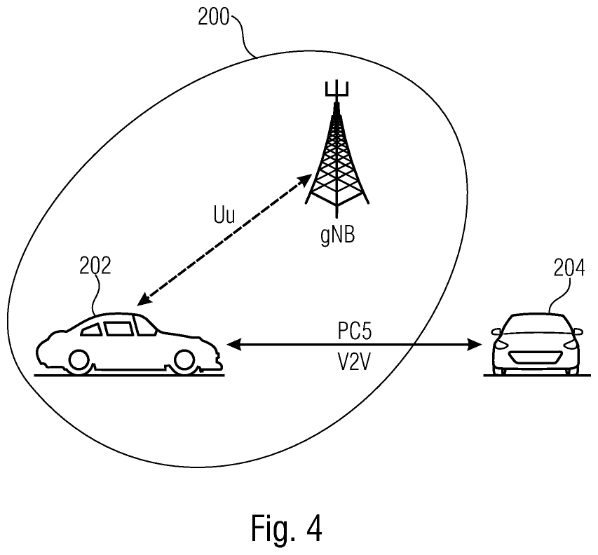

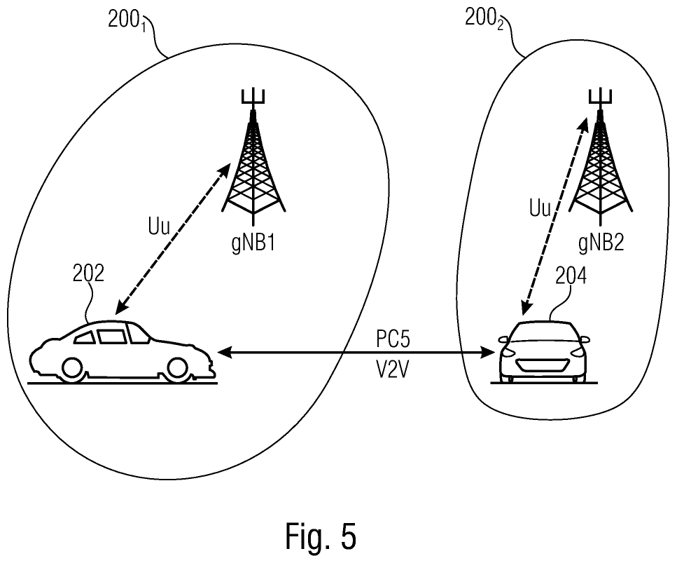

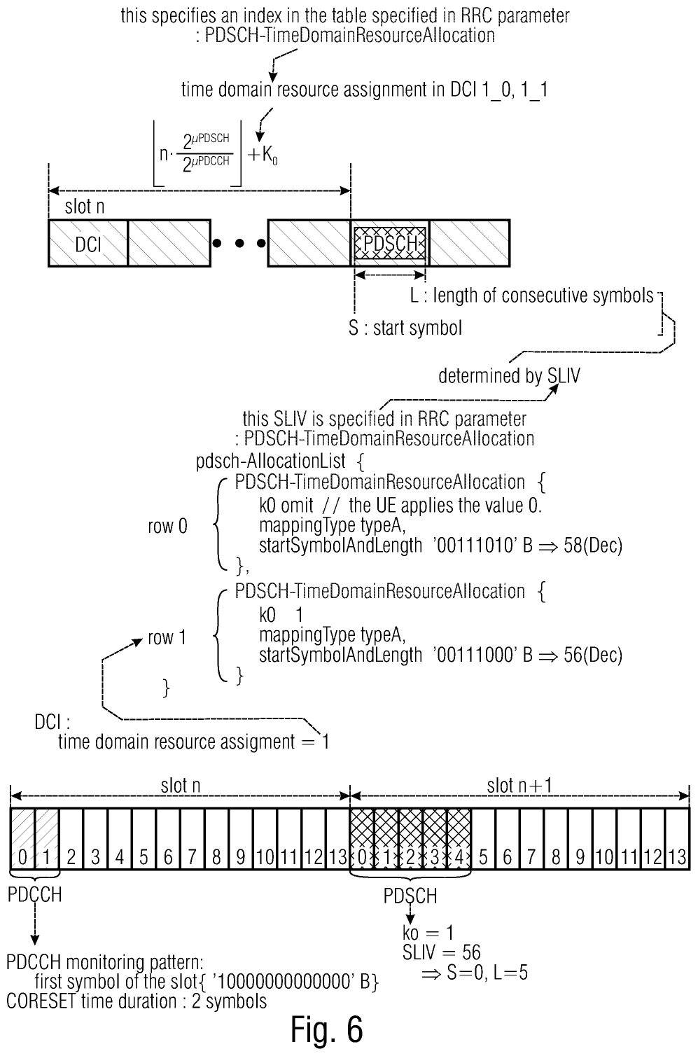

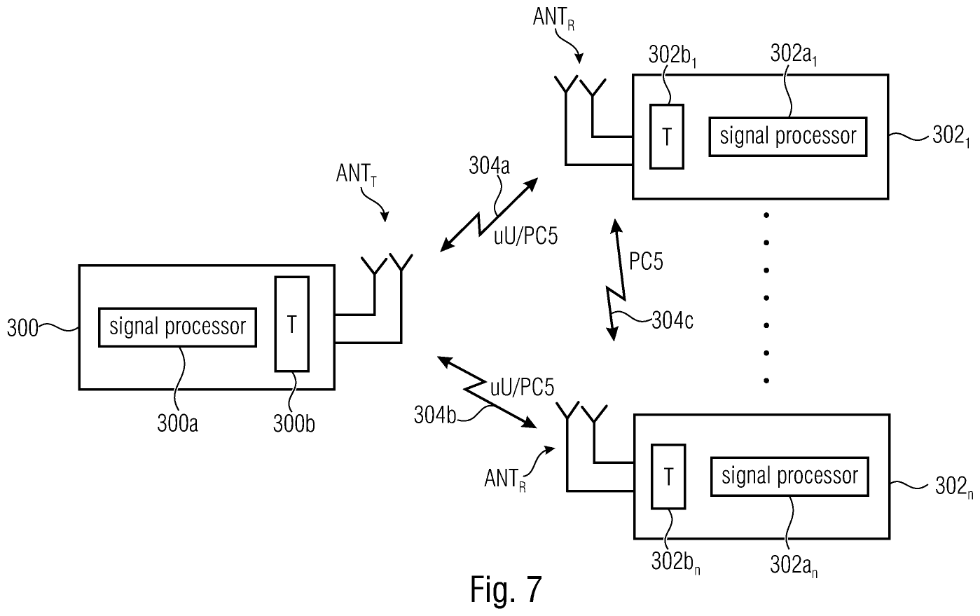

Embodiments of the present invention may be implemented in a wireless communication system as depicted in FIGS. 1-5 including base stations and users, like mobile terminals or IoT devices. FIG. 7 is a schematic representation of a wireless communication system including a central transceiver, like a base station, and one or more transceivers 3021 to 302n, like user devices, UEs. The central transceiver 300 and the transceivers 302 may communicate via one or more wireless communication links or channels 304a, 304b, 304c, like a radio link. The central transceiver 300 may include one or more antennas ANTT or an antenna array having a plurality of antenna elements, a signal processor 300a and a transceiver unit 300b, coupled with each other. The transceivers 302 include one or more antennas ANTR or an antenna array having a plurality of antennas, a signal processor 302a1, 302an, and a transceiver unit 302b1, 302bn coupled with each other. The base station 300 and the UEs 302 may communicate via respective first wireless communication links 304a and 304b, like a radio link using the Uu interface, while the UEs 302 may communicate with each other via a second wireless communication link 304c, like a radio link using the PC5 interface. When the UEs are not served by the base station, are not be connected to a base station, for example, they are not in an RRC connected state, or, more generally, when no SL resource allocation configuration or assistance is provided by a base station, the UEs may communicate with each other over the sidelink. The system, the one or more UEs and the base stations may operate in accordance with the inventive teachings described herein.

Embodiments provide a transceiver [e.g., UE] of a wireless communication system, wherein the transceiver is configured to receive a first control message [e.g., in a first slot or subframe, such as slot or subframe n] [e.g., comprising a first control information or control configuration], wherein the transceiver is configured to receive a second control message [e.g., in a second slot or subframe, such as slot or subframe n+koff−Δ] [e.g., comprising a second control information or control configuration], wherein the second control message is linked [e.g., refers] to the first control message by an identifier, ID [e.g., DCI/base grant ID], or indication, wherein one out of
the first control message,
the first control message and the second control message together,
the second control message,
   grant or assign a resource to the transceiver for a communication of the transceiver.

In embodiments, the communication is:
an uplink communication (e.g., using Uu), or
a downlink communication (e.g., using Uu), or
a sidelink communication (e.g., using PC5), or
a backhaul communication (e.g., IAB using Uu), or
a relaying communication (e.g. using PC5 or Uu).

In embodiments, the second control message [e.g., second control information or control configuration] is configured to one or more out of
modify the first control message [e.g., first control information or control configuration],
form a new control message [e.g., information or control configuration],
extend the first control message [e.g., first control information or control configuration],
replace the first control message [e.g., first control information or control configuration],
revoke [e.g., canceling] the first control message [e.g., first control information or control configuration].

For example, the first control message is extended by mandatory or optional parameters. E.g., the first control message does not contain all information to receive/assign the grant. Or additional parameters are added, e.g., MIMO layer beam forming, additional/new component carrier.

In embodiments, the transceiver is configured,
in case that the second control message modifies the first control message, to perform the communication, in dependence on the second control message, in the resource granted or assigned to the transceiver or a new resource granted or assigned to the transceiver by a modified version of the first control message modified by the second control message, or
in case that the second control message replaces the first control message, to perform the communication, in dependence on the second control message, in a new resource granted or assigned to the transceiver by the second control message, or
in case that the second control message forms the new message, to perform the communication in a new resource granted or assigned to the transceiver by the new control message, or
in case that the second control message revokes the first control message, to not perform the communication, or
in case that the second control message extends the first control message, to add at least one parameter to the second control message to the first control message and/or to combine at least one parameter of the second control message with a corresponding parameter of the first control message.

For example, in case the base grant is RRC configured it is not a first control information itself. If the base grant is signaled over PDCCH it is a downlink control Information (DCI). In this case it points to a granted UL/DL/SL resource. When it is configured over RRC it is a configuration. So it provides as configuration essentially the same information as the DCI above but it is not used as a grant itself. The second control message would then use the delta signaling which is applied on top of this configuration to form a grant.]

For example, the first control message could just point to a carrier, whereas the second control message contains the grant or resource assignment.

In embodiments, the first control message is received via
a physical downlink control channel, PDCCH,
or a physical sidelink control channel, PSCCH,
or a physical sidelink shared channel, PSSCH.

In embodiments, the first control message comprises a first control information or a first control configuration.

In embodiments, the first control information is
a first downlink control information, DCI,
or a first sidelink control information, SCI,
or a first sidelink assistance information message, AIM.

In embodiments, in case that the first control information is a sidelink control information, SCI, the sidelink control information, SCI, is transmitted via the 1^{st}-stage or 2^{nd}-stage or both stages of the sidelink control information, SCI, and/or wherein in case that the first control information is a first sidelink assistance information message, AIM, the first sidelink assistance information message, AIM, is transmitted via the 1^{st}-stage or 2^{nd}-stage or both stages of the sidelink assistance information message, AIM.

In embodiments, the 1^{st}-stage or 2^{nd}-stage sidelink control information, SCI, points to a sidelink assistance information message, AIM, which is send in a sidelink data channel [e.g., PSSCH; e.g., via MAC CE].

In embodiments, the first control configuration is a radio resource control, RRC, configuration.

In embodiments, the second control message is received via
a physical downlink control channel, PDCCH,
or a physical downlink shared channel, PDSCH, [e.g., by adding the control information (e.g., MAC Control Element) to a scheduled downlink data transmission],
or a physical sidelink control channel, PSCCH,
or a physical sidelink shared channel. PSSCH.

In embodiments, the second control message comprises a second control information or a second control configuration.

In embodiments, the second control information is
a second downlink control information, DCI,
or a second sidelink control information, SCI,
or a sidelink assistance information message, AIM.

In embodiments, the second control configuration is a second radio resource control, RRC, configuration.

For example, in this casen the RRC configuration would update/extend/modify/revoke/cancel the first RRC configuration. However, it might not be used as a grant/assignment itself but just update the base grant to be used for future second messages.

In embodiments, at least one out of the first control message [e.g., the first control information] and the second control message [e.g., the second control information] comprises a control information [e.g., a value [e.g., offset value, such as koff]] indicating the resource granted/assigned to the transceiver for the communication, and/or wherein at least one out of the first control message [e.g., the first control information] and the second control message [e.g., the second control information] comprises a control information or control configuration indicating at least one communication parameter [e.g., transmission or reception parameter] to be used for the communication.

In embodiments, the control information of the first control message or the second control message comprises a value [e.g., offset value, such as koff] indicating the resource granted/assigned to the transceiver for the communication.

In embodiments, the second control message is transmitted in a time interval [n; n+koff] between the reception of the first control message and the resource granted or assigned to the transceiver.

In embodiments, the first control message is received in a first resource [e.g., in a first slot or subframe, such as slot or subframe n], wherein the second control message is received in a second slot or subframe, such as slot or subframe n+koff−Δ], wherein the second resource occurs in a time interval [n; n+koff] between the first resource and the resource granted or assigned to the transceiver.

In embodiments, the second control message comprises a second control information or control configuration that is differentially encoded with respect to a first control information or control configuration of the first control message [e.g., by encoding changes of transmission parameters].

In embodiments, the second control message [e.g., the second control information or control configuration of the control message] grants or assigns a further resource to the transceiver for a further communication.

In embodiments, the first control message [e.g., the first control information or control configuration of the first control message] grants or assigns the resource to the transceiver.

In embodiments, the second control message encodes changes of at least one transmission parameter of the further communication and/or further resource compared to at least one corresponding transmission parameter of the communication and/or resource.

In embodiments, the at least one transmission parameter is one or more out of
a carrier indicator indicating a component carrier
a bandwidth-part, BWP, indicator used for activating one of a at least two bandwidth-parts,
a frequency allocation,
a time allocation within a slot,
a VRB-to-PRB mapping describing if interleaved or non-interleaved VRB-to-PRB mapping is used,
a time offset between DCI and PDSCH/PUSCH,
a MCS,
and antenna port/Beam related parameters [e.g., TCI, SRS request, DM-RS sequence initialization].
a HARQ-related parameter [e.g., HARQ process number, DAI, HARQ feedback timing indicator, CBG transmission indicator and/or CBG flush information],
a PUCCH power control,
a PUCCH resource indicator.

In embodiments, the second control message comprises a control information [e.g., downlink control information], wherein a first proper subset of bits [e.g., n bits] of the control information define at least one transmission parameters that is changed and an associated encoding [e.g. the parameter id and the number of bits related to that change].

In embodiments, the first control message [e.g., the first control information or control configuration of the first control message] granting or assigning the resource for the communication to the transceiver forms a current base grant, wherein the second control message [e.g., the second control information or control configuration of the second control message] granting or assigning the further resource for the further communication to the transceiver forms a new candidate base grant, wherein the new candidate base grant replaces the current base grant.

In embodiments, the new candidate base grant replaces the current base grant if the new candidate base grant is acknowledged by the wireless communication system [e.g., a base station].

In embodiments, the transceiver is configured to receive a third control message comprising a third control information or control configuration that is differentially encoded with respect to the current base grant.

In embodiments, the first control message [e.g., the first control information or control configuration of the first control message] granting or assigning the resource for the communication to the transceiver forms a first base grant, wherein the second control message [e.g., the second control information or control configuration of the second control message] granting or assigning the further resource for the further communication to the transceiver forms a second base grant.

In embodiments, the transceiver is configured to receive a third control message comprising a third control information or control configuration that is differentially encoded with respect to the first base grant or the second base grant.

In embodiments, a field in the third control information indicates the base grant to which respect it is encoded.

In embodiments, the transceiver is configured to operate in an [e.g., new radio, NR; 5G] in-coverage scenario or relay scenario [e.g., radio resource control, RRC, connected mode], in which resources are scheduled by the wireless communication system [e.g., base station [e.g., gNB], relay, UE, S-UE, road side unit RSU, group lead, GL, UE, or any other scheduling entity of the wireless communication system], and/or wherein the transceiver is configured to operate in a [e.g., new radio, NR] sidelink in-coverage, out of coverage or partial coverage scenario [e.g., NR sidelink mode [e.g., mode 1 or mode 2]], in which resources are pre-configured by the wireless communication system or allocated or scheduled autonomously by the transceiver.

Further embodiments provide a transceiver [e.g., base station] of a wireless communication system, wherein the transceiver is configured to transmit a first control message [e.g., in a first slot or subframe, such as slot or subframe n] [e.g., comprising a first control information or control configuration], wherein the transceiver is configured to transmit a second control message [e.g., in a second slot or subframe, such as slot or subframe n+koff−Δ] [e.g., comprising a second control information or control configuration], wherein the second control message is linked [e.g., refers] to the first control message by an identifier, ID [e.g., DCI/base grant ID], or indication, wherein one out of
the first control message,
the first control message and the second control message together,
the second control message,
   grant or assign a resource to another transceiver [e.g., UE] for a communication of the other transceiver.

In embodiments, the communication is:
an uplink communication (e.g., using Uu), or
a downlink communication (e.g., using Uu), or
a sidelink communication (e.g., using PC5), or
a backhaul communication (e.g., IAB using Uu), or
a relaying communication (e.g. using PC5 or Uu).

In embodiments, the second control message [e.g., second control information or control configuration] is configured to one or more out of
modify the first control message [e.g., first control information or control configuration],
form a new control message [e.g., information or control configuration],
extend the first control message [e.g., first control information or control configuration],
replace the first control message [e.g., first control information or control configuration],
revoke [e.g., canceling] the first control message [e.g., first control information or control configuration].

For example, the first control message is extended by mandatory or optional parameters. E.g., the first control message does not contain all information to receive/assign the grant. Or additional parameters are added, e.g., MIMO layer beam forming, additional/new component carrier.

In embodiments,
in case that the second control message modifies the first control message, the communication is performed by the other transceiver, in dependence on the second control message, in the resource granted or assigned to the other transceiver or a new resource granted or assigned to the other transceiver by a modified version of the first control message modified by the second control message, or
in case that the second control message replaces the first control message, the communication is performed by the other transceiver, in dependence on the second control message, in a new resource granted or assigned to the other transceiver by the second control message, or
in case that the second control message forms the new message, the communication is performed by the other transceiver in a new resource granted or assigned to the other transceiver by the new control message, or
in case that the second control message revokes the first control message, the communication is not performed by the other transceiver, or
in case that the second control message extends the first control message, at least one parameter of the second control message is added to the first control message and/or at least one parameter of the second control message is combined with a corresponding parameter of the first control message.

In embodiments, the first control message is transmitted via
a physical downlink control channel, PDCCH,
or a physical sidelink control channel, PSCCH,
or a physical sidelink shared channel, PSSCH.

In embodiments, the first control message comprises a first control information or a first control configuration.

In embodiments, the first control information is
a first downlink control information, DCI,
or a first sidelink control information, SCI,
or a first sidelink assistance information message, AIM.

In embodiments, in case that the first control information is a sidelink control information, SCI, the sidelink control information, SCI, is transmitted via the 1^{st}-stage or 2^{nd}-stage or both stages of the sidelink control information, SCI, and/or wherein in case that the first control information is a first sidelink assistance information message, AIM, the first sidelink assistance information message, AIM, is transmitted via the 1^{st}-stage or 2^{nd}-stage or both stages of the sidelink assistance information message, AIM.

In embodiments, the 1^{st}-stage or 2^{nd}-stage sidelink control information, SCI, points to a sidelink assistance information message, AIM, which is send in a sidelink data channel [e.g., PSSCH; e.g., via MAC CE].

In embodiments, the first control configuration is a radio resource control, RRC, configuration.

In embodiments, the second control message is transmitted via
a physical downlink control channel, PDCCH,
or a physical downlink shared channel, PDSCH, [e.g., by adding the control information (e.g., MAC Control Element) to a scheduled downlink data transmission],
or a physical sidelink control channel, PSCCH,
or a physical sidelink shared channel. PSSCH.

In embodiments, the second control message comprises a second control information or a second control configuration.

In embodiments, the second control information is
a second downlink control information, DCI,
or a second sidelink control information, SCI,
or a sidelink assistance information message, AIM.

In embodiments, the second control configuration is a second radio resource control, RRC, configuration.

In embodiments, at least one out of the first control message [e.g., the first control information] and the second control message [e.g., the second control information] comprises a control information [e.g., a value [e.g., offset value, such as koff]] indicating the resource granted/assigned to the other transceiver for the communication, and/or wherein at least one out of the first control message [e.g., the first control information] and the second control message [e.g., the second control information] comprises a control information or control configuration indicating at least one communication parameter [e.g., transmission or reception parameter] to be used for the communication.

In embodiments, the control information of the first control message or the second control message comprises a value [e.g., offset value, such as koff]] indicating the resource granted/assigned to the other transceiver for the communication.

In embodiments, the second control message is transmitted in a time interval [n; n+koff] between the reception of the first control message and the resource granted or assigned to the other transceiver.

In embodiments, the first control message is transmitted in a first resource [e.g., in a first slot or subframe, such as slot or subframe n], wherein the second control message is transmitted in a second slot or subframe, such as slot or subframe n+koff−Δ], wherein the second resource occurs in a time interval [n; n+koff] between the first resource and the resource granted or assigned to the other transceiver.

In embodiments, the second control message comprises a second control information or control configuration that is differentially encoded with respect to a first control information or control configuration of the first control message [e.g., by encoding changes of transmission parameters].

In embodiments, the second control message [e.g., the second control information or control configuration of the control message] grants or assigns a further resource to the other transceiver for a further communication.

In embodiments, the first control message [e.g., the first control information or control configuration of the first control message] grants or assigns the resource to the other transceiver.

In embodiments, the second control message encodes changes of at least one transmission parameter of the further communication and/or further resource compared to at least one corresponding transmission parameter of the communication and/or resource.

In embodiments, the at least one transmission parameter is one or more out of
a carrier indicator indicating a component carrier
a bandwidth-part, BWP, indicator used for activating one of a at least two bandwidth-parts,
a frequency allocation,
a time allocation within a slot,
a VRB-to-PRB mapping describing if interleaved or non-interleaved VRB-to-PRB mapping is used,
a time offset between DCI and PDSCH/PUSCH,
a MCS,
and antenna port/Beam related parameters [e.g., TCI, SRS request, DM-RS sequence initialization],
a HARQ-related parameter [e.g., HARQ process number, DAI, HARQ feedback timing indicator, CBG transmission indicator and/or CBG flush information],
a PUCCH power control,
a PUCCH resource indicator.

In embodiments, the second control message comprises a control information [e.g., downlink control information], wherein a first proper subset of bits [e.g., n bits] of the control information define at least one transmission parameters that is changed and an associated encoding [e.g. the parameter id and the number of bits related to that change].

In embodiments, the first control message [e.g., the first control information or control configuration of the first control message] granting or assigning the resource for the communication to the other transceiver forms a current base grant, wherein the second control message [e.g., the second control information or control configuration of the second control message] granting or assigning the further resource for the further communication to the other transceiver forms a new candidate base grant, wherein the new candidate base grant replaces the current base grant.

In embodiments, the new candidate base grant replaces the current base grant if the new candidate base grant is acknowledged by the transceiver.

In embodiments, the transceiver is configured to transmit a third control message comprising a third control information or control configuration that is differentially encoded with respect to the current base grant.

In embodiments, the first control message [e.g., the first control information or control configuration of the first control message] granting or assigning the resource for the communication to the other transceiver forms a first base grant, wherein the second control message [e.g., the second control information or control configuration of the second control message] granting or assigning the further resource for the further communication to the other transceiver forms a second base grant.

In embodiments, the transceiver is configured to transmit a third control message comprising a third control information or control configuration that is differentially encoded with respect to the first base grant or the second base grant.

In embodiments, a field in the third control information indicates the base grant to which respect it is encoded.

In embodiments, the transceiver is configured to operate in an [e.g., new radio, NR; 5G] in-coverage scenario or relay scenario [e.g., radio resource control, RRC, connected mode], in which resources are scheduled by the wireless communication system [e.g., base station [e.g., gNB], relay, UE, S-UE, road side unit RSU, group lead, GL, UE, or any other scheduling entity of the wireless communication system], and/or wherein the transceiver is configured to operate in a [e.g., new radio, NR] sidelink in-coverage, out of coverage or partial coverage scenario [e.g., NR sidelink mode [e.g., mode 1 or mode 2]], in which resources are pre-configured by the wireless communication system or allocated or scheduled autonomously by the transceiver.

Further embodiments provide a method for operating a transceiver. The method comprises a step of receiving a first control message [e.g., in a first slot or subframe, such as slot or subframe n] [e.g., comprising a first control information or control configuration]. Further, the method comprises a step of receiving a second control message [e.g., in a second slot or subframe, such as slot or subframe n+koff−Δ] [e.g., comprising a second control information or control configuration], wherein the second control message is linked [e.g., refers] to the first control message by an identifier, ID [e.g., DCI/base grant ID], or indication, wherein one out of the first control message,
the first control message and the second control message together,
the second control message,
   grant or assign a resource to the transceiver for a communication of the transceiver.

Further embodiments provide a method for operating a transceiver. The method comprises a step of transmitting a first control message [e.g., in a first slot or subframe, such as slot or subframe n] [e.g., comprising a first control information or control configuration]. Further, the method comprises a step of transmitting a second control message [e.g., in a second slot or subframe, such as slot or subframe n+koff−Δ] [e.g., comprising a second control information or control configuration], wherein the second control message is linked [e.g., refers] to the first control message by an identifier, ID [e.g., DCI/base grant ID], or indication, wherein one out of
the first control message,
the first control message and the second control message together,
the second control message,
   grant or assign a resource to another transceiver for a communication of the other transceiver.

Subsequently, embodiments of the present invention are described in further detail.

### Embodiment 1: Allow Modification of Grant Transmission Parameters and/or Cancel Grants or Postpone Grants

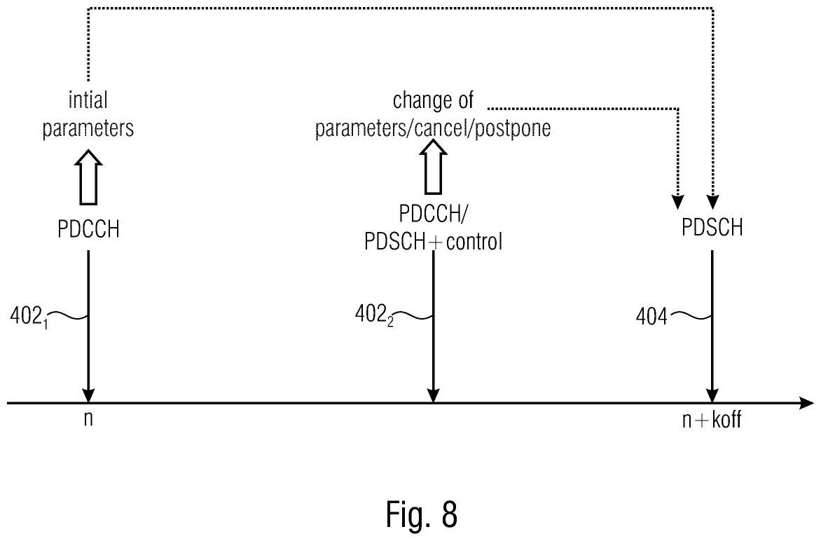

To allow modification of grant transmission parameters and/or cancel grants or postpone grants, in embodiments, a signaling mechanism occurs within the interval [n,n+k_{off}−Δ], as illustrated in FIG. 8.

In detail, FIG. 8 shows in a diagram an illustrative view of a transmission of control messages for allocating/scheduling a grant and modifying said grant, in accordance with an embodiment. Thereby, the abscissa denotes the time. As shown in FIG. 8, at time instant n, a first control message 402₁ is transmitted to a transceiver (e.g., UE), the first control message 402₁ comprising a first control information granting or assigning a resource to the transceiver (e.g., UE). Further, in the time interval [n, n+k_{off}] a second control message 402₂ is transmitted to the transceiver (e.g., UE), the second control message 402₂ comprising a second control information, wherein the second control information (1) modifies the first control information, (2) forms a new control information, (3) extends the first control information, (4) replaces the first control information or (5) revokes the first control information, thereby modifying, canceling or postponing the resource assigned to the transceiver (e.g., UE). The first control message 402₁ can be transmitted, for example, via PDCCH, wherein the second control message 402₂ can be transmitted, for example, via PDCCH/PDSCH+Control. At time instant n+k_{off}, the transceiver (e.g., UE) can perform, for example, a communication 404 in the resource assigned to the transceiver by the first and second control information. In other words, FIG. 8 shows an illustration of a modification of scheduling grant.

In embodiments, the modification channel may be a separate PDCCH, PSCCH or a piggyback of control information along with another PDSCH/PSSCH that has been allocated by another PDCCH/PSCCH (earlier or after) or semi-persistent scheduling/configured grant mechanism (i.e., SPS in LTE), occurring in the interval [n,n+k_{off}−Δ] or a new control message, e.g., DCI, which indicates being a “modification” message, e.g., explicit field in DCI, indicating a change and the assigned base grant, i.e., the time/frequency allocation, DCI/base grant ID or HARQ ID. A DCI piggyback may be obtained as a multiplexing of control and data at the bit level, as a MAC control element or RRC signaling.

The modifiable transmission parameters may be pre-configured or fixed, e.g., by the standard. The amount of bits needed can be reduced by encoding the change of parameters instead of the absolute values of the parameters.

### Embodiment 2: Incremental DCI for Frequent Allocations

For a burst of data that needs frequent scheduling grants but not in a periodic way (periodic ones can be handled by semi-persistent/configured grant scheduling), a sequence of scheduling grants are needed. Since channel conditions over a short period of time are expected to change slowly and similarities (of packets) are expected within a burst, several grant transmission parameters may change only slightly over the burst duration.

Therefore, embodiments provide an efficient way of signaling by starting the burst using a normal scheduling grant with all the parameters indicated and construct DCI for the subsequent grants in an incremental fashion.

In case there are more than one service flows running in a BWP, a DCI/base grant ID as stated above can be used to differentiate to which service flow the DCI delta update belongs to. For this, depending on the number of parallel services, n-bits of the reserved fields of the DCI format 1_0 could be used. In case the bits for this should be spared, and in case that there is only a single service flow per carrier or per BWP, the carrier indicator or the BWP indicator can be used as indication in order to differentiate between delta updates for a base DCI on one carrier/BWP and a delta update on another carrier/BWP.

In embodiments, for a burst needing N grants, the following method can be followed to construct scheduling DCI:
Grant 1: Normal grant DCI encodes all transmission parameters. Alternatively, the initial set of parameters may be also provided by semi-static signaling, e.g., RRC, MAC control element or SI.
Grant 2: DCI grant encodes changes (Delta 2) to all or a subset of transmission parameters in Grant 1. UE constructs the complete grant by including the changes to the DCI of Grant 1 (Grant 2=Grant 1+Delta 2).
Grant 3: DCI grant encodes changes (Delta 3) to all or a subset of transmission parameters in complete grant corresponding to Grant 2. UE constructs the complete grant by including the changes to the parameters of Grant 2 (Grant 3=Grant 2+Delta3). To mitigate conflicting references (UE and base station might have different base grants) the incremental Grant can indicate to which base grant it refers to or reference the latest “acknowledged” grant as base grant.
[ . . . ]
Grant N: DCI grant encodes changes (Delta N) to all or a subset of transmission parameters in complete grant corresponding to Grant N−1. UE constructs the complete grant by including the changes to the parameters of Grant N−1 (Grant N=Grant N−1+Delta N).

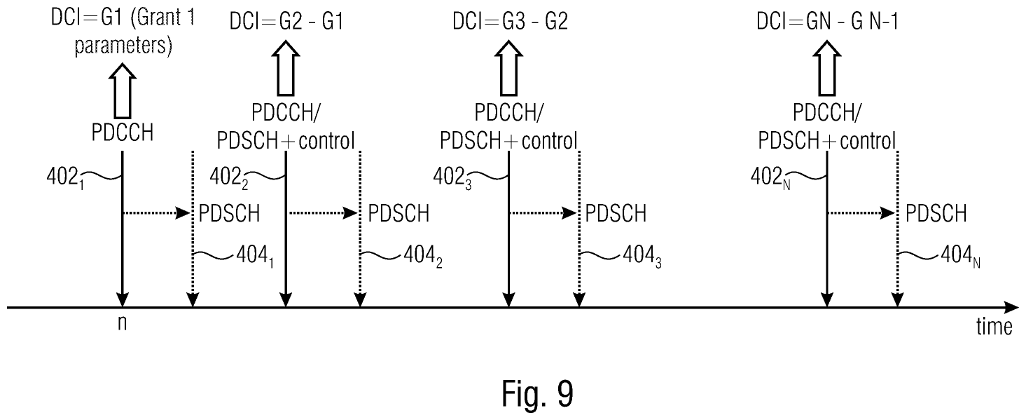

FIG. 9 shows in a diagram an illustrative view of a transmission of a sequence of control messages for allocating/scheduling grants for bursty traffic, according to an embodiment. Thereby, the abscissa denotes the time. As shown in FIG. 9, in a first step, a first control message 402₁ is transmitted to the transceiver (e.g., UE), the first control message 402₁ comprising a first control information granting or assigning a first resource to the transceiver (e.g., UE), wherein the transceiver is configured to perform a first communication 404₁ in the first resource. In a second step, a second control message 402₂ is transmitted to the transceiver (e.g., UE), the second control message 402₂ comprising a second control information that updates/modifies the first control information, to obtain an updated/modified second control information that grants or assigns a second resource to the transceiver (e.g., UE), wherein the transceiver is configured to perform a second communication 404₂ in the second resource. In a third step, a third control message 402₃ is transmitted to the transceiver (e.g., UE), the third control message 402₃ comprising a third control information that updates/modifies the updated/modified second control information, to obtain an updated/modified third control information that grants or assigns a third resource to the transceiver (e.g., UE), wherein the transceiver is configured to perform a third communication 404₃ in the third resource. In an Nth step, an Nth control message 402_{N} is transmitted to the transceiver (e.g., UE), the Nth control message 402_{N} comprising an Nth control information that updates/modifies the updated/modified N−1th control information, to obtain an updated/modified Nth control information that grants or assigns a third resource to the transceiver (e.g., UE), wherein the transceiver is configured to perform an Nth communication 404_{N} in the third resource. In other words, FIG. 9 shows an illustration of incremental DCI.

Alternatively, in embodiments, the first grant or RRC sets the initial set of parameters, e.g., one or more of the following:
carrier indicator, indicating the component carrier if cross-carrier scheduling is configured;
bandwidth-part (BWP) indicator, used for activating one of up to four BWPs;
frequency allocation;
time allocation within a slot;
VRB-to-PRB mapping, describing if interleaved or non-interleaved VRB-to-PRB mapping is used;
time offset between DCI and PDSCH/PUSCH;
MCS;
antenna port/beam related parameters, TCI, SRS request, DM-RS sequence initialization;
HARQ-related information: HARQ process number, DAI, HARQ feedback timing indicator, CBG transmission indicator, CBG flush information;
PUCCH power control, PUCCH resource indicator.

Thereby, the second grant to the Nth grant may signal the delta information relative to the initial setup/set of parameters.

Alternatively, in embodiments, a base grant and delta information may be used. Thereby, the base grant and/or modifications to it can be signaled via DCI. The changes can be applied, for example, once acknowledged or after a certain time. In a further embodiment, the base grant can be initially set up and or modified by RRC signaling.

In embodiments, the base grant or modifications to it can be indicated in the DCI itself (flag) or marked otherwise, e.g., by scrambling with a different RNTI or being of a higher aggregation level.

In embodiments, the following grants are then signaled as a delta to the base grant.

Subsequently, a delta signaling example is provided.

A format indicator may be used in the DCI itself to indicate which parts of the initial setup are to be signaled in the same DCI. Depending on that indicator a subset of the initial setup parameters may be signaled by that DCI. The values of these fields may be signaled as delta values or explicit values so that the UE overwrites the corresponding field for the specific grant/scheduling assignment.

The subset of transmission parameters included in the change encoding may be fixed or configured. For example, this may include MCS, resource allocation parameters, HARQ process number etc.

DCIs may be carried by a PDCCH or using data the piggyback method.

### Embodiment 3: New DCI Format “DELTA”

In embodiments, a new (DCI) DELTA format is provided. In embodiments, the first n bits (of the new DCI DELTA format) define the parameters that will be changed and the associated encoding, e.g., the parameter id and the number of bits related to that change. Thereby, n can be configurable or pre-configured.

In embodiments, the DCI format comprises a certain number of bits at the beginning, that indicate which parameters are included in this DCI and how many bits every parameter will have and their positions.

Table 1 shows an example of a DELTA DCI with a plurality of bits.

TABLE 1

| # of bits | Field Name | Comment |
|---|---|---|
| 3 | DeltaType | Indicated the parameters to |
| | | be changed |
| 0 {Field not present} | MCS | Modulation Coding Scheme |
| 2 {−2 . . . +2} | | |
| 4 {Full MCS} | | |
| 0 {field not present} | TFAllocation | Time/Frequency Allocation |
| 4 {Delta Informatio} | | |
| 8 {Full TFA} | | |
| 0 {Field not present} | HARQID | HARQ Process ID |
| 2 {ID} | | |
| 4 {ID} | | |

Table 2 shows an example of a DELTA DCI with more than one base grant with a plurality of bits.

TABLE 2

| # of bits | Field Name | Comment |
|---|---|---|
| n | Base Grant | Base grant id the delta is |
| | | applied to |
| 3 | DeltaType | Indicated the parameters to |
| | | be changed |
| 0 {Field not present} | MCS | Modulation Coding Scheme |
| 2 {−2 . . . +2} | | |
| 4 {Full MCS} | | |
| 0 {field not present} | TFAllocation | Time/Frequency Allocation |
| 4 {Delta Informatio} | | |
| 8 {Full TFA} | | |
| 0 {Field not present} | HARQID | HARQ Process ID |
| 2 {ID} | | |
| 4 {ID} | | |

In embodiments, RRC information for DELTA types may have the following form:

```
List{
  {delta type 01
    {MCS {enum{0,2,4},
    TFAllocation {enum{0, 4, 8, 12... M},
    [...]
    }
  },
  {delta type 02
    {MCS {enum{0,2,4}, SF{ enum{2,4,8}[OPT]},
    [...]
    }
  },
  {delta type 03
    { Scaling Factor {enum{2,4,8},
    [...]
    }
  }
}
```

Thereby, “scaling factor” can be type specific or parameter specific and can be configured via RRC only if the parameter is present.

Updating the Base Grant with a Delta Signaling

In this scenario, the base grant is constantly updated with the delta signaling, i.e. base grant+delta=new base grant.

This however can lead to cases where the base station and the UE have a different understanding of what the current base grant is, for example, if a delta message is misinterpreted/missed/could not be decoded.

To avoid this, in embodiments, a base grant is only updated with new delta grant or a new base grant once the grant itself or the corresponding data is acknowledged to the base station. This can further include a processing time after which the grant is applied.

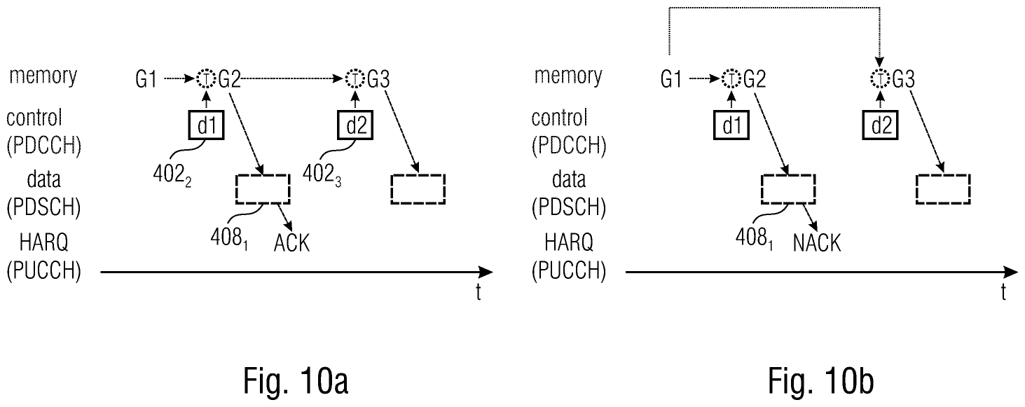

An example of this is shown in FIGS. 10a and 10b. Specifically, FIGS. 10a and 10b show in diagrams illustrative views of transmissions of sequences of control messages, the control messages comprising control information updating a base grant (delta signaling), according to an embodiment of the present invention. Thereby, the abscissas denote the time.

In FIGS. 10a and 10b it is assumed that the base grant is communicated to the transceiver (e.g., UE) via a first control message, such as RRC (not shown in FIGS. 10a and 10b), or is pre-configured. In FIG. 10a, a second control message 402₂ is transmitted to the transceiver (e.g., UE), the second control message 402₂ comprising a second control information updating the base grant (first grant, G1), to obtain a second grant (G2), which is acknowledged by a further control message 408₁ (e.g., transmitted on the PDSCH). Therefore, the third control message 402₂ which is transmitted to the transceiver (e.g., UE) and that comprises a third control information is used to update the second grant (G2), to obtain a third grant (G3), i.e. G2=G1+delta. In contrast to that, in the example shown in FIG. 10b, the second grant (G2) is not acknowledged by a further control message 408₁, such that the third control message 402₂ which is transmitted to the transceiver (e.g., UE) and that comprises a third control information is used to update the base grant (G2), to obtain a third grant (G3), i.e. G3=G1+delta. In other words, FIGS. 10a and 10b show delta signaling handling.

In FIG. 10a it can be seen that the data grant the second grant (G2) points to is acknowledged after which the second grant (G2) becomes the new base grant and the second delta signaling (d2) is now applied on top of the new base grant (G2).

In FIG. 10b it can be seen that the first base grant (G1) and the first delta signaling (d1) form the second grant (G2). The UE cannot decode the corresponding data and sends a NACK. In this case, the first grant (G1) stays the base grant and the second delta signaling (d2) is applied on top of the first grant (G1) to form the new third grant (G3).

If the first delta signaling (d1) is missed completely, the UE might also not send HARQ feedback. In this case, the base station receives nothing and the base grant also stays as the first grant (G1).

Further, the gNB may also miss HARQ feedback from the UE or a bit flip (ACK-NACK) may occur. In that case, also the previously described approach would go into an error state. To avoid that the gNB may indicate the base grant in the incremental DCI. To address the issue of missed DCI, it may only indicate DCIs which have been acknowledged (ACKed) already.

The base grant may be indicated by an identifier, a slot number or monitoring occasion number in an absolute or relative manner.

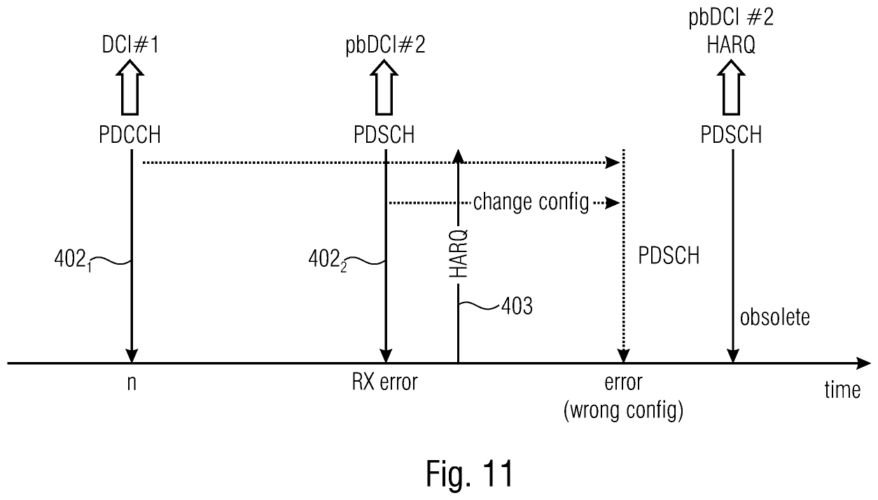

FIG. 11 shows in a diagram a scenario where incremental DCI is not received correctly, according to an embodiment. For example, FIG. 11 shows in a diagram an illustrative view of a transmission of a sequence of control messages for allocating/scheduling grants, wherein some of the control messages are not received correctly, according to an embodiment of the present invention. Thereby, the abscissa denotes the time. As shown in FIG. 9, in a first step, a first control message 402₁ is transmitted to the transceiver (e.g., UE), the first control message 402₁ comprising a first control information granting or assigning a first resource to the transceiver (e.g., UE). In a second step, a second control message 402₂ is transmitted to the transceiver (e.g., UE), the second control message 402₂ comprising a second control information that updates/modifies the first control information. However, the second control message 402₂ is not received correctly. Therefore a HARQ message 403 is transmitted by the transceiver (e.g., UE), indicating that the second control message 402₂ is not received correctly.

### Further Embodiments

Embodiments described herein enable the gNB to change already sent downlink scheduling grants in order to:
fulfill QoS requirements of the UE or other UEs,
adopt parameters, i.e. MCS, for the already scheduled transmission, and/or
cancel scheduling for any reason suitable to the gNB
   while maintaining the benefits of koff scheduling.

Embodiments offer more flexibility to the gNB in order to adopt its scheduling in case of fast changing channels, unforeseen QOS challenges or other circumstances that need the grant to be changed in order to optimize the overall system performance.

Embodiments enable a flexible use of predefined resources while using the k0 offset scheduling method for resource reservation and enabling power saving features and extending sleep times.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

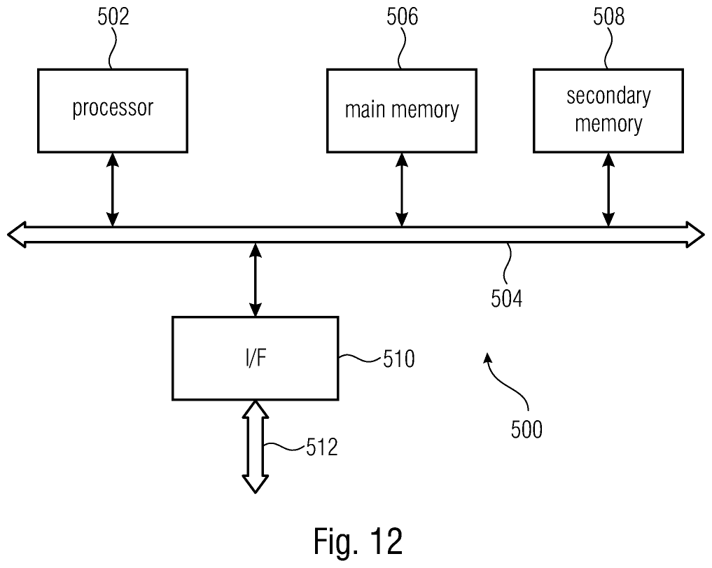

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### ABBREVIATIONS

MCR minimum communication range

NR new radio

LTE long term evolution

UMTS universal mobile telecommunication system

UE user equipment

BS base station

NB node B

gNB next generation node B—base station

D2D device-to-device

V2V vehicle-to-vehicle

V2X vehicle-to-everything

IoT Internet of things

PDSCH physical downlink shared channel

PDCCH physical downlink control channel

PUSCH physical uplink shared channel

PUCCH physical uplink control channel

PSSCH physical sidelink shared channel

PSCCH physical sidelink control channel

PBCH physical broadcast channel

PRACH physical random access channel

DCI downlink control information

SCI sidelink control information

UCI uplink control information

SIB system information block

MIB master information block

TTI transmission time interval

SL sidelink

SI system information

RAN radio access networks

RS reference symbols/signal

OFDM orthogonal frequency-division multiplexing

TDD time division duplex

BWP bandwidth part

MAC medium access control

PRB physical resource block

VRB virtual resource block

MCS modulation and coding scheme

HARQ hybrid automatic repeat request

DAI downlink assignment index

CBG code block group

RNTI radio network temporary identifier

### REFERENCES

[1] http://www.sharetechnote.com/html/5G/5G_ResourceAllocation.html
[2] R1-2004494, “Considerations for PDCCH Monitoring Reduction and Power Saving of RedCap Devices”, Qualcomm Incorporated

1. Transceiver of a wireless communication system,
wherein the transceiver is configured to receive a first control message,
wherein the transceiver is configured to receive a second control message,
wherein the second control message is linked to the first control message by an identifier, ID, or indication,
wherein the first control message and the second control message together grant or assign a resource to the transceiver for a communication of the transceiver.

2. Transceiver of a wireless communication system,
wherein the transceiver is configured to transmit a first control message,
wherein the transceiver is configured to transmit a second control message,
wherein the second control message is linked to the first control message by an identifier, ID, or indication,
wherein the first control message and the second control message together grant or assign a resource to another transceiver for a communication of the other transceiver.

3. Transceiver according to claim 1,
wherein the communication is:
an uplink communication, or
a downlink communication, or
a sidelink communication, or
a backhaul communication, or
a relaying communication.

4. Transceiver according to claim 1,
wherein the second control message is configured to one or more out of
modify the first control message,
form a new control message,
extend the first control message,
replace the first control message,
revoke the first control message.

5. The transceiver according to claim 4,
wherein the transceiver is configured, in case that the second control message modifies the first control message, to perform the communication, in dependence on the second control message, in the resource granted or assigned to the transceiver or a new resource granted or assigned to the transceiver by a modified version of the first control message modified by the second control message,
or wherein the transceiver is configured, in case that the second control message replaces the first control message, to perform the communication, in dependence on the second control message, in a new resource granted or assigned to the transceiver by the second control message,
or wherein the transceiver is configured, in case that the second control message forms the new message, to perform the communication in a new resource granted or assigned to the transceiver by the new control message,
or wherein the transceiver is configured, in case that the second control message revokes the first control message, to not perform the communication.
or wherein the transceiver is configured, in case that the second control message extends the first control message, to add at least one parameter to the second control message to the first control message and/or to combine at least one parameter of the second control message with a corresponding parameter of the first control message.

6. Transceiver according to claim 1,
wherein the first control message is received via
a physical downlink control channel, PDCCH,
or a physical sidelink control channel, PSCCH,
or a physical sidelink shared channel, PSSCH,
and/or wherein the second control message is received via
a physical downlink control channel, PDCCH,
or a physical downlink shared channel, PDSCH,
or a physical sidelink control channel, PSCCH,
or a physical sidelink shared channel. PSSCH.

7. Transceiver according to claim 1,
wherein the first control message comprises a first control information or a first control configuration,
and/or wherein wherein the second control message comprises a second control information or a second control configuration.

8. Transceiver according to claim 1,
wherein the first control configuration is a radio resource control, RRC, configuration.

9. Transceiver according to one of the preceding claims,
wherein at least one out of the first control message and the second control message comprises a control information indicating the resource granted/assigned to the transceiver for the communication,
and/or wherein at least one out of the first control message and the second control message comprises a control information or control configuration indicating at least one communication parameter to be used for the communication.

10. Transceiver according to claim 1,
wherein the second control message is transmitted in a time interval between the reception of the first control message and the resource granted or assigned to the transceiver.

11. Transceiver according to claim 1,
wherein the first control message is received in a first resource,
wherein the second control message is received in a second resource,
wherein the second resource occurs in a time interval between the first resource and the resource granted or assigned to the transceiver.

12. Transceiver according to claim 1,
wherein the second control message comprises a second control information or control configuration that is differentially encoded with respect to a first control information or control configuration of the first control message.

13. Transceiver according to claim 12,
wherein the second control message grants or assigns a further resource to the transceiver for a further communication.

14. Transceiver according to claim 12,
wherein the first control message grants or assigns the resource to the transceiver.

15. Transceiver according to claim 14,
wherein the second control message encodes changes of at least one transmission parameter of the further communication and/or further resource compared to at least one corresponding transmission parameter of the communication and/or resource.

16. Transceiver according to claim 12,
wherein the first control message granting or assigning the resource for the communication to the transceiver forms a current base grant,
wherein the second control message granting or assigning the further resource for the further communication to the transceiver forms a new candidate base grant,
wherein the new candidate base grant replaces the current base grant.

17. Transceiver according to claim 1,
wherein the transceiver is configured to operate in an in-coverage scenario or relay scenario, in which resources are scheduled by the wireless communication system,
and/or wherein the transceiver is configured to operate in a sidelink in-coverage, out of coverage or partial coverage scenario, in which resources are pre-configured by the wireless communication system or allocated or scheduled autonomously by the transceiver.

18. Method for operating a transceiver, the method comprising:
receiving a first control message,
receiving a second control message,
wherein the second control message is linked to the first control message by an identifier, ID, or indication,
wherein the first control message and the second control message together grant or assign a resource to the transceiver for a communication of the transceiver.

19. Method for operating a transceiver, the method comprising:
transmitting a first control message,
transmitting a second control message,
wherein the second control message is linked to the first control message by an identifier, ID, or indication,
wherein the first control message and the second control message together grant or assign a resource to another transceiver for a communication of the other transceiver.

20. A non-transitory digital storage medium having a computer program stored thereon to perform the method for operating a transceiver, the method comprising:
receiving a first control message,
receiving a second control message,
wherein the second control message is linked to the first control message by an identifier, ID, or indication,
wherein the first control message and the second control message together grant or assign a resource to the transceiver for a communication of the transceiver.
when said computer program is run by a computer.
